(19) United States
(12) Patent Application Publication
(10) Pub. No.: US 2007/0023566 A1
(43) Pub. Date: Feb. 1, 2007

(54) Flying all-terrain vehicle

(76) Inventor: Kenneth D. Howard, Plymouth, IN (US)

Correspondence Address: REINHART BOERNER VAN DEUREN P.C., 2215 PERRYGREEN WAY, ROCKFORD, IL, 61107, US

(21) Appl. No.: 11/192,920

(22) Filed: Jul. 29, 2005

Related U.S. Application Data
(60) Provisional application No. 60/603,974, filed on Aug. 24, 2004.

(51) Int. Cl. B64C 37/02

(52) U.S. Cl. 244/2

(57) ABSTRACT

A method and apparatus are provided for constructing, operating, and marketing a vehicle that is alternatively adaptable for controlled, powered operation on the ground as an all-terrain vehicle (ATV), or in the air as a powered parachute, or for controlled, powered operation on both the ground and in the air as a flying ATV. On the ground, the vehicle is configured for controlled, powered operation over both smooth and rough terrain, as a true all-terrain vehicle.

### CROSS-REFERENCE TO RELATED PATENT APPLICATIONS

This patent application claims the benefit of U.S. Provisional Application No. 60/603,974, filed Aug. 24, 2004, the disclosure of which is incorporated herein by reference in its entirety.

### FIELD OF THE INVENTION

This invention relates to vehicles that are capable of powered operation on the ground and in the air, and more specifically to a vehicle that is capable of operation alternatively on the ground, in the air, or both on the ground and in the air.

### BACKGROUND OF THE INVENTION

It has long been desired to have a vehicle that is capable of controlled powered operation both on the ground and in the air. It has been particularly desirable to have an all-terrain vehicle (ATV) that can be either flown or driven to and from a remote location, over smooth or rough terrain, for operation on either the ground or in the air after reaching the remote location. For such operation, a flying ATV must be capable of taking off and landing under its own power, and be controllable while in the air. For ground operation, such a flying ATV must be capable of normal driving functions, including steering and braking, while traveling across either smooth or rough terrain.

Such a flying ATV would have numerous civilian and military applications.

For civilian use, it is desirable that a flying ATV be capable of meeting applicable government regulations pertaining to operation of such vehicles, during both airborne and terrestrial operation. For example, it may be desirable in some applications to have a flying ATV that is capable of meeting FAA regulations allowing the vehicle to be flown by a pilot having a Sport Aviation rating. For ground operation, it may be desirable to have a flying ATV include appropriate lights and turn signals, etc., so that the vehicle may be driven on a public road, and/or appropriate lighting for operating the vehicle off-road at night.

For either military or civilian use, it is desirable to have such a flying ATV be compact in size, so that it may be readily stored and transported. It is further desirable that such a flying ATV have a construction that is sufficiently rugged, and including suspension components providing adequate ground clearance for controllable operation over rough terrain. It is further desirable that such a flying ATV be constructed in a manner conducive to mass production, at reasonable cost, and offering reliable operation over a long operating life of the vehicle with a reasonable amount of maintenance and minimal repair.

Previous attempts and approaches to producing a flying ATV have been purely conceptual, or have proved to be either impractical or unworkable. For example, published United States Patent Application No. US 2003/0218099, to Preston, purports to disclose a multimodal vehicle including a ground-based vehicle with an attached high-capacity airfoil parachute that is deployable following discharge of the ground-operable vehicle from an aircraft, while the aircraft is in flight. The ground-based vehicle of Preston purports to include a drive system for use on either land, water or both, with the vehicle being sized and dimensioned for transport of multiple vehicles in a cargo plane. The high-capacity airfoil parachute of Preston, purports to allow high-altitude deployment of the vehicle, with the risers of the parachute being adjustable from a first to a second position for powered parachute flight rather than freefall flight, so that the vehicle can purportedly be re-deployed, once on the ground, in a manner allowing it to take off and fly from the ground after being dropped from the aircraft. Preston further discloses that the vehicle may include a propeller for powered flight, preferably driven by the same motor that operates drive wheels attached to the ground vehicle for independent operation.

The drawings of the Preston application are cartoon-like conceptual sketches, at best, and are non-enabling with regard to adequately teaching those skilled in the art how to practice the concepts disclosed in Preston's application. In addition, the prosecution history for the Preston application is completely devoid of any indication that Preston had actually reduced his invention to practice, as of the filing date of the application for the present invention.

In addition to being non-enabling and only disclosing a concept for the construction and operation of the purported multimodal deployable vehicle, the application of Preston further discloses an unworkable concept for converting a ram air parachute, of the type utilized for dropping the multimodal vehicle from an aircraft, for use as a parachute capable of allowing the multimodal vehicle to lift off from the ground under its own power. Those skilled in the art will readily recognize that due to the large forces exerted on ram air parachutes capable of allowing a load the size of such a multimodal vehicle to be launched from an aircraft in flight, at typical air speeds of 150 to 200 MPH, such a parachute must be robust in nature and, of necessity, be much heavier than the type of parachute typically used for powered flight by powered parachute-type vehicles flying at maximum speeds of 25 to 60 MPH. As a result, those skilled in the art would also readily recognize that a parachute heavy enough to allow such in-flight deployment, would be far too heavy to be inflated by an air propeller of such a multimodal vehicle attempting to take off from the ground.

In another prior approach, which has actually been reduced to practice, a powered parachute machine having an engine-driven propeller as its sole means of propulsion is modified to add additional wheels, skis, and/or floats, to provide a vehicle which has some capability for operation on relatively smooth terrain, on snow or ice, and/or as a watercraft, in addition to being flyable as a powered parachute. One version of such a device, in the form of a propeller-driven powered parachute/snowmobile appeared in the James Bond movie, “The World is Not Enough—007.” Other machines of this type have been produced and operated both in the air and on a smooth terrestrial surface or water by Para-Ski International, and in the form of a vehicle marketed under the name Jet Wing ATV in the early 1980s.

While these propeller-driven machines purported to have some “ATV-like” capabilities for operation both in the air and on the ground or over water, they proved to be largely impractical, without the benefit of Hollywood cinematography, under actual operating conditions, and have not achieved any commercial or military viability. Such machines have proven to be only marginally capable of traversing relatively smooth terrestrial surfaces at low speeds. Such prior machines have not included sufficient suspension and other construction details to allow them to be operated at higher speeds over rough terrain. They are incapable of climbing any grade beyond relatively slight inclines, because they lack sufficient thrust to overcome resistance with the ground and weight of the machine. They also have not proved to be sufficiently steerable or otherwise controllable, when operating on the ground or on water.

In addition, propeller-driven machines are not allowed, by government regulation, to operate on public roads. The propellers of such machines have also been shown to be highly susceptible to damage and early failure when impacted by water droplets, snow and ice, or dirt and dust during operation on the ground.

Use of a single engine for propelling a vehicle both in flight and on the ground, by driving a propeller is also undesirable, because aircraft engines are limited by government regulation to a specified number of operational hours between maintenance activities. It is therefore, inefficient and costly to utilize the aircraft engine for propelling a vehicle on the ground.

In another prior approach, which was actually reduced to practice, a machine called the “Flite Bike” was produced and operated both on the ground and in the air, during mid-2001. The Flite Bike combined a Buckeye Powered Parachute, having a special frame configured for attachment thereto of a Honda Reflex motorcycle. The Flite Bike included a pair of outrigger wheels supported on adjustable air shocks extending from either side of the motorcycle. When used as a powered parachute, the air shocks were inflated by an onboard compressor to raise the rear motorcycle wheel off the ground and transfer the weight normally supported by the rear motorcycle wheel to the outriggers, which also extended outward for additional stability when the Flight Bike was operating as a powered parachute.

Although the Flite Bike did indeed operate both on the ground and in the air, performance in either mode was significantly diminished below what it would have been for a powered parachute, or a motorcycle operating alone. On the ground, the additional outrigger wheels caused the motorcycle to handle more like a tricycle than a well-manner road bike, and introduced steering and control instabilities typical of tricycle-type machines. In the air, the performance of the Flite Bike proved to be less than stellar, and the design did not qualify for operation by an unlicensed pilot, under government regulations as the manufactures had hoped. The Flite Bike had not become commercially viable at the time of filing the application for the present invention. It will also be apparent to those skilled in the art that the Flite Bike was only capable of operation over smooth terrain.

For reasons including those stated above, no prior known approach has provided a successful flying ATV, in light of the definition of an ATV, as provided by the American Heritage Dictionary of the English Language, Fourth Edition, Copyright 2000 by Houghton Mifflin Company, which defines an ATV as “[a] small, open motor vehicle having one seat and three or more wheels fitted with large tires . . . designed chiefly for recreational use over roadless, rugged terrain”.

In contrast to prior concepts and approaches for providing a flying ATV, those skilled in the art will readily recognize that practice of the present invention, as defined herein, does indeed provide a practical flying ATV, as clearly evidenced by 81 pages of photographs of a prototype flying ATV, according to the present invention, included in the Applicant's priority provisional patent application, and incorporated herein by reference as stated above. The photos in the priority provisional patent application clearly show the prototype flying ATV, embodying the present invention, operating on the ground, as an ATV, and in flight as a powered parachute. The Applicants prototype flying ATV has also been featured in internationally circulated publications, including Outdoor Life Magazine, and EAA Sport Aviation. The prototype has also been featured on websites of the Experimental Aircraft Association (EAA), and Buckeye Aviation, and has been exhibited and operated, both in the air and the ground at air shows. Several flying ATVs, in accordance with the invention, are also expected to enter service in government border control operations, subsequent to the filing date of the present patent application.

It will be further noted that the invention provides a flying ATV that is capable of carrying two or more passengers and/or a significant amount of cargo of on-board equipment.

### BRIEF SUMMARY OF THE INVENTION

The invention provides a vehicle that is capable of configuration for controlled powered operation on the ground, or in the air, or both on the ground and in the air.

In one form of the invention, the vehicle is adaptable for controlled powered operation on the ground as an all terrain vehicle (ATV), or in the air as an aircraft, or for controlled powered operation both on the ground and in the air. In one form of the invention, the vehicle is an ATV configured for controlled powered operation on the ground, and adapted for attachment of a powered parachute apparatus for controlled powered operation in the air. In another form of the invention, the vehicle is a powered parachute configured for controlled powered flight, and adapted for attachment of components allowing controlled powered operation on the ground. When operated as a powered parachute, the vehicle is capable of taking off and landing under its own power.

A vehicle according to the invention may include a wing structure, in forms other than a powered parachute, including but not limited to various rigid and flexible wing structures such as delta wing arrangement, or various fixed wing configurations.

In some forms of the invention, the vehicle may include separate air and ground power apparatuses for operation in the air and on the ground. It is preferred that the propeller of the power parachute apparatus be separately driven so that it can be shut down during operation of the vehicle in ground mode, because government regulations do not allow operation of the propeller while the vehicle is operating on a road surface. In some forms of the invention, it may be desirable to operate the ground power apparatus during take-off in the powered parachute operating mode, in order to reduce the time and distance required for achieving airborne flight.

It is also desirable to have the aircraft engine be separate, because the number of operational hours on the aircraft engine are greatly reduced in comparison to what they would be if the aircraft engine were used for both air and ground operation. The ground engine is not subject to the type of inspections and limitations on operating hours between maintenance and overhaul that are prudent and imposed by governmental regulations on the aircraft engine, making it preferable to operate the vehicle on the ground with the ground engine.

The vehicle may include partially or completely separate controls for operation on the ground and in flight.

In one form of the invention, a single throttle control may be operatively connected to both the air and ground power apparatuses for simultaneously controlling both the air and ground power apparatuses. The throttle control may include a single “gas pedal” type control in the vehicle, and/or may also include a throttle locking device for maintaining a constant throttle position while in flight and/or on the ground.

The ground and air power apparatuses may include any appropriate form of a prime mover, such as one or more electrical motors, gas or steam turbines, or diesel or internal combustion engines. Where engines are used, they may be air or liquid cooled, two or four cycle, and may include oil injection systems for two cycle engines. It is preferred that the ground and air power apparatuses each include a separate engine, or other form of prime mover.

In some forms of the invention, the vehicle includes a chassis, and a ground power apparatus operatively attached to the chassis, with the ground power apparatus including three or more wheels, at least one of which is steerable, and at least one of which is powered. A suspension system may operatively connect the wheels to the chassis. The suspension system may include adjustable suspension elements, such as pneumatic shocks or struts, which can be adjusted to provide desired ride or handling characteristics, or to raise or lower the chassis with respect to the ground. It may be desirable, for example, to increase the stiffness of the suspension during take-off and landing, and then reduce the stiffness during ground operation to provide a softer ride or better handling while on the ground.

The ground power apparatus may include a brake acting on one or more of the wheels that is capable of controlling the vehicle while operating on the ground. The brake may include a locking device for holding the vehicle in place during run-up of the air power apparatus. The brake may be hydraulic, and may be include a disk brake having a rotor operatively attached to at least one of the wheels, and a hydraulically actuated caliper.

The chassis of the vehicle may include both a main frame and a secondary frame, operatively attached to the main frame. One or more of the wheels may be operatively attached to the secondary frame. The secondary frame may be articulated from the main frame, and in some embodiments, may be connected to the main frame at the rear of the main frame. Portions of the suspension may connect the secondary frame to the main frame.

The secondary frame may include mounting provisions for one or more components of the ground power apparatus, such as an engine and transmission. A drive axle may be attached to the secondary frame, and be operatively connected to an engine or other prime mover of the ground power apparatus. The drive axle may be connected to the other portions of the ground power apparatus by a drive element, such as a chain, a belt, or a gear. A disk brake rotor may be attached to the drive axle.

The vehicle may resemble a conventional ATV, dune buggy or go-kart, but would preferably have a longer wheelbase to facilitate steering of the vehicle on the ground during operation of the vehicle as an aircraft, for example during taxiing, take-off and landing.

The vehicle may include structures such as, outriggers extending from the main frame for attachment of a wing structure, such as a ram-air type parachute or canopy, a rigid fixed or removable wing, a delta wing arrangement, or other types of airfoil or wing structures. The vehicle may also include a prop shroud, a motor mount for a motor driving a prop, and other structures extending from the main frame for mounting elements of the air power apparatus, or devices for controlling the chute of a powered parachute, or flight control surfaces, to steer the vehicle while in flight. These outriggers and prop shroud, etc., may be removable, so that the vehicle may be used or sold initially as an ATV, and later retrofitted with the outriggers, prop shroud, chute, air power apparatus and controls necessary to convert the ATV into a flying ATV. Alternatively, the outriggers may be used on the vehicle, when configured only as an ATV, to perform other functions, such as providing roll-over protection or mounting of devices for carrying cargo or accessories attached to the vehicle.

The lower portion of the prop shroud may be omitted in some embodiments of the vehicle, rather than being a complete circle as in prior powered parachutes. Omitting the lower portion of the prop shroud is advantageous in that it provides more ground clearance during ground powered operation as an ATV, and precludes having the lower portion of the prop shroud becoming caught on objects protruding from the ground. In embodiments having an articulated secondary frame at the rear of a main frame, omitting the lower portion of the prop shroud provides more clearance for the secondary frame and ground power engine, etc., to move upward when the ATV is traveling over uneven ground.

The vehicle may include an actuator apparatus for steering during operation as a powered parachute, rather than the foot powered steering bars or levers used in prior powered parachutes. The actuator apparatus is operatively connected to steering lines, extending from the parachute, that are selectively pulled to change the shape of the inflated chute to steer the vehicle in flight. The actuator apparatus may include one or more controllable actuators for selectively pulling on the steering lines. In various embodiments of the invention, these actuators may be actuated mechanically, electrically, hydraulically, pneumatically, or otherwise actuated from an on-board power source.

In a preferred embodiment, the actuators are pneumatically powered by an on-board compressor, and are attached to the steering lines in such a manner the actuators can pull the steering lines a larger distance than is provided by the stroke of a linearly movable element of the actuator. For example, the steering line may be doubled back from a pulley on the movable element so that the linear distance that the movable element moves results in the steering line being pulled a distance that is approximately twice the linear distance that the movable element moves. This allows an actuator having a linear stroke of approximately 10 inches, for example, being able to move the steering line a distance of approximately 20 inches. A distance of about 20 inches is typically needed to change the airfoil shape of the chute enough to cause the vehicle to turn effectively. In prior power chutes, foot operated steering bars or levers are typically used for pulling the steering lines, but such foot operated steering devices cannot be used in some vehicles, because they would interfere with operation of the vehicle on the ground as an ATV.

The actuator apparatus may include a control element operatively connected to the actuator for controlling pulling of the steering lines. The control element has the ability to pull on the steering line, or to release tension on the steering line, for steering the vehicle in flight. Preferably, the control element can also hold the steering line in a desired position without the operator continually applying force to an input element of the control element, so that the chute can be held by the actuation apparatus in a desired airfoil shape during circling, or when the vehicle is “crabbing” into a cross wind to maintain a desired direction of straight flight.

The vehicle may also include a glide shield to provide improved fuel economy in the flight mode, and lower engine RPM, to increase engine life, in addition to improving the glide ratio. In some forms of the invention, the vehicle includes a floor pan under the main frame, or other structures which are shaped to function also as a glide shield.

Where it is desirable to operate the vehicle only as a powered parachute, or to sell it initially without the ground power unit for later upgrade to add ATV capabilities, the ground power apparatus components may be excluded. Where the vehicle includes a secondary frame, in these instances, the ground power apparatus components may be left off of the secondary frame, or a secondary frame having a different configuration can be utilized while the vehicle is configured for operation exclusively as a powered parachute. For example, the secondary frame might have only one centrally located wheel, in such embodiments.

The invention may also take the form of a method for constructing, operating, or selling a vehicle as disclosed herein.

Other advantages, aspects and elements of the invention will be apparent from the following detailed description of exemplary embodiments, when taken together with the accompanying attachments.

### DESCRIPTION OF THE DRAWINGS

FIG. 1 is a perspective illustration of a first exemplary embodiment of a flying ATV, according to the invention, rigged for ground operation;

FIG. 2 is a perspective illustration of the first exemplary embodiment of the invention shown in FIG. 1, with the flying ATV in flight and carrying two persons;

FIG. 3 is a perspective view taken from the right rear comer of the first exemplary embodiment of the invention shown in FIGS. 1 and 2;

FIG. 4 is a perspective view of a portion of the drive train and braking apparatus of the first exemplary embodiment of the flying ATV shown in FIGS. 1-3;

FIG. 5 is a perspective illustration of a pneumatic steering apparatus, according to the invention;

FIG. 6 is an exploded perspective view of the first exemplary embodiment shown in FIGS. 1-4, illustrating modular construction aspects of the invention, which allow a vehicle, according to the invention, to be adapted for sale and/or use exclusively on the ground, exclusively in flight, or both on the ground and in flight;

FIG. 7 and 8 are partial cut-away orthographic views illustrating a brake locking apparatus, according to the invention, which may be utilized by an operator of a flying ATV, according to the invention, when seated aboard, or standing next to the flying ATV of FIGS. 1-4;

FIGS. 9-11 are, respectively, perspective side, front, and rear views of a second exemplary embodiment of a flying ATV, according to the invention, with FIG. 9 showing the second exemplary embodiment as it would appear when suspended by a parachute in flight, and FIG. 10 showing the second exemplary embodiment rigged for ground operation, with the parachute stowed in a stowage bag suspended from a chassis of the flying ATV;

FIGS. 12-14 illustrate a foot-pedal-powered actuator apparatus of the second exemplary embodiment of the flying ATV of FIGS. 9-11, which is used for controlling steering lines of the parachute in flight.

FIGS. 15-17 illustrate construction details of a dual compartment fuel tank, and fluid connections from the fuel tank to a ground power unit, and an aircraft engine, of the second exemplary embodiment of the flying ATV shown in FIGS. 9-11.

While the invention will be described in connection with certain preferred embodiments, there is no intent to limit it to those embodiments. On the contrary, the intent is to cover all alternatives, modifications and equivalents as included within the spirit and scope of the invention.

### DESCRIPTION OF EXEMPLARY EMBODIMENTS OF THE INVENTION

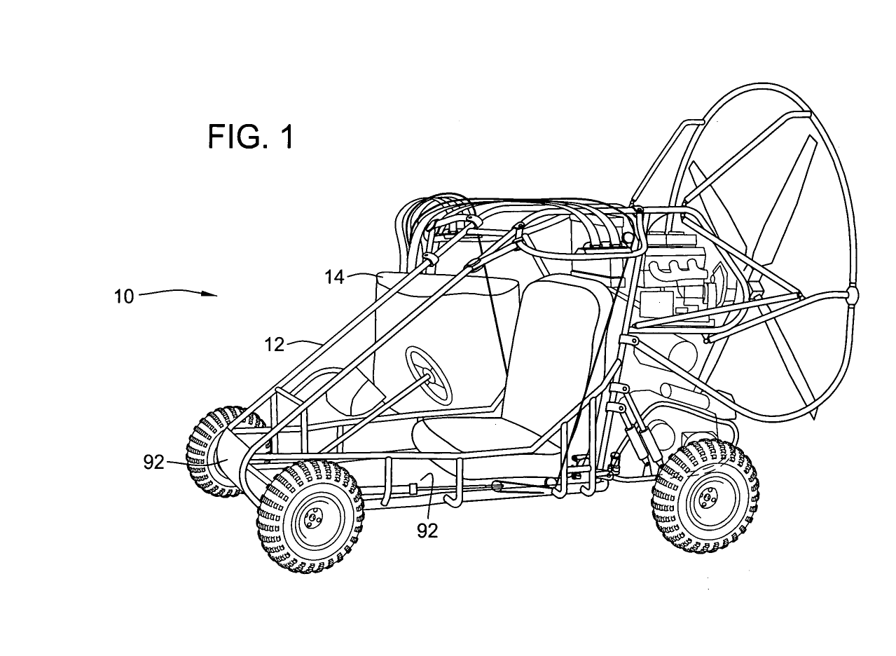

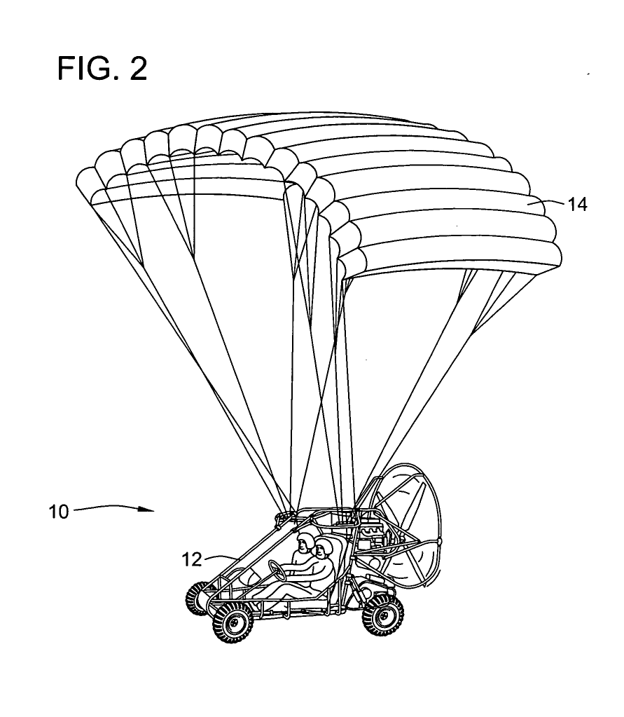

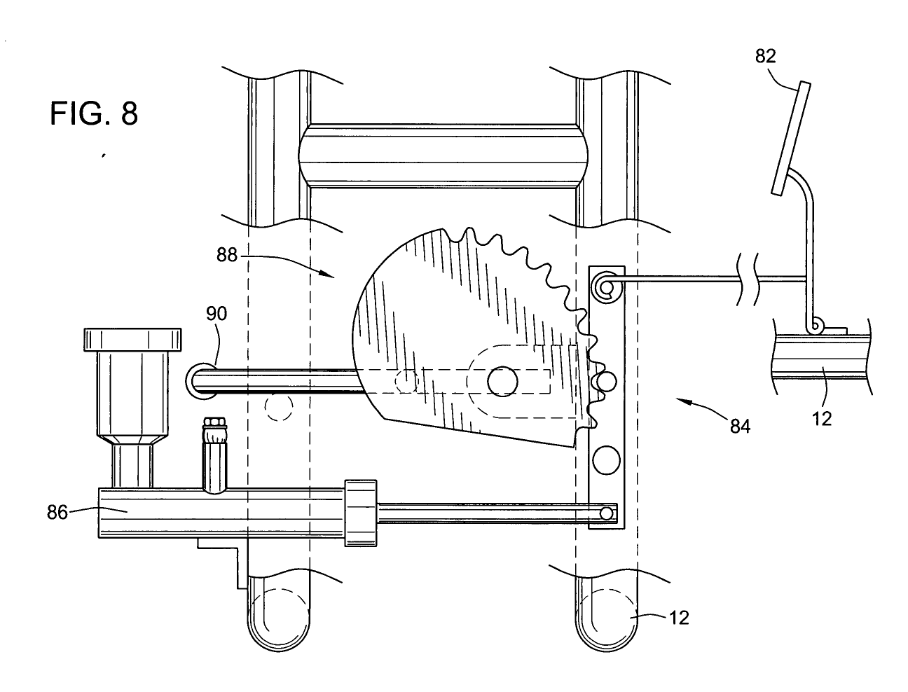

FIGS. 1-8 show a first exemplary embodiment of a vehicle 10, according to the invention, in the form of flying ATV, which is configured for controlled powered operation both on the ground, as shown in FIG. 1 and in the air, as shown in FIG. 2.

As shown in FIG. 2, the vehicle 10 includes a chassis 12, a chute 14 attached to the chassis, and other components as described below, also attached to the chassis 12, for ground and air operation of the vehicle 10. The chute 14 (also known as a canopy) of the exemplary embodiment is of the typical ram air canopy type.

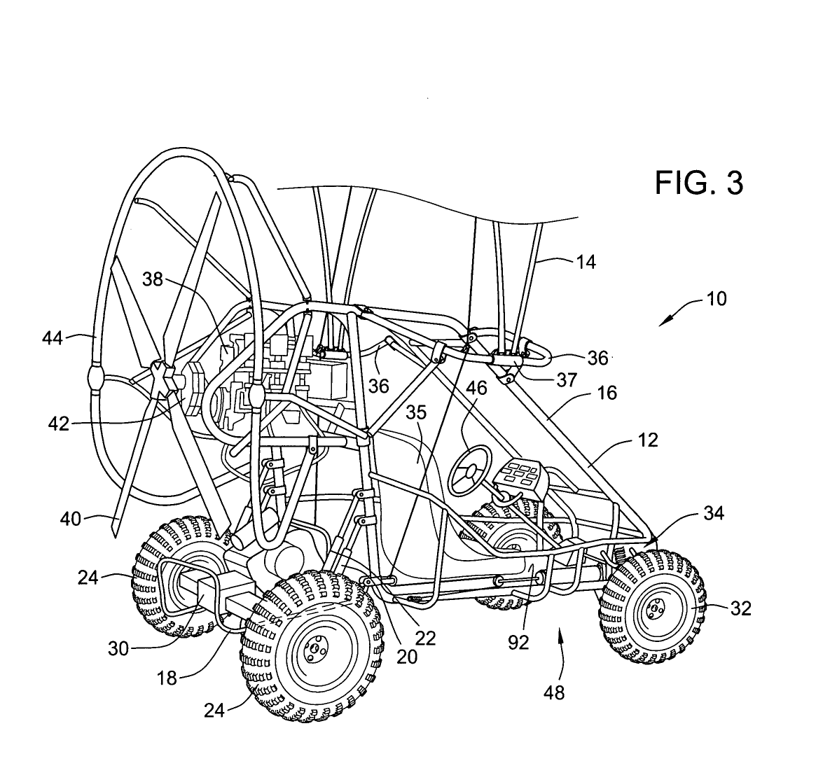

As shown in FIG. 3, the chassis 12 of the first exemplary embodiment includes a main frame 16, and a secondary frame 18 having a front end thereof pivotably attached to the rear end of the main frame 16, for articulating movement relative to the main frame 16. Two pairs of rear suspension struts 20, 22 are operatively connected between the secondary frame 18 and the main frame 16 to control movement of the secondary frame with respect to the main frame 16.

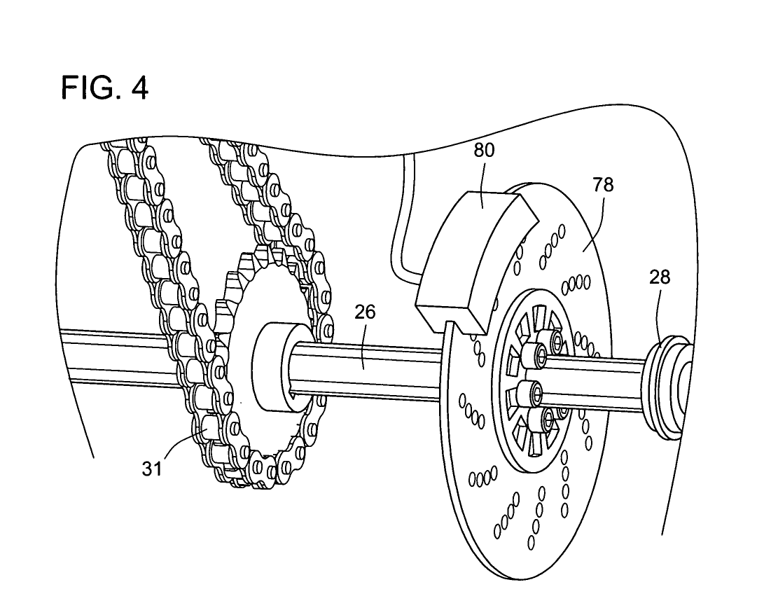

As shown in FIG. 4, rear wheels 24 of the first exemplary embodiment are attached at right and left ends of a solid axle 26, which is journalled in bearings 28 attached to the secondary frame 18. A ground propulsion engine and transmission unit 30 are mounted on the secondary frame 18, and operatively connected to the rear axle 26 through a chain and sprocket drive arrangement 31. The transmission on the engine and transmission unit 30 of the exemplary embodiment is an automatic transmission, having a clutch arrangement that leaves the rear axle 26 free to rotate when ground propulsion engine 30 is not running or is operating at idle speed.

As shown in FIG. 3, two steerable front wheels 32 are operatively mounted to the front end of the main frame 16 by a front suspension and steering system, generally indicated as reference numeral 34. It will be recognized by those having skill in the art that the invention can be practiced with efficacy using many other forms of 2-wheel and 4-wheel drive systems, suspensions and steering arrangements.

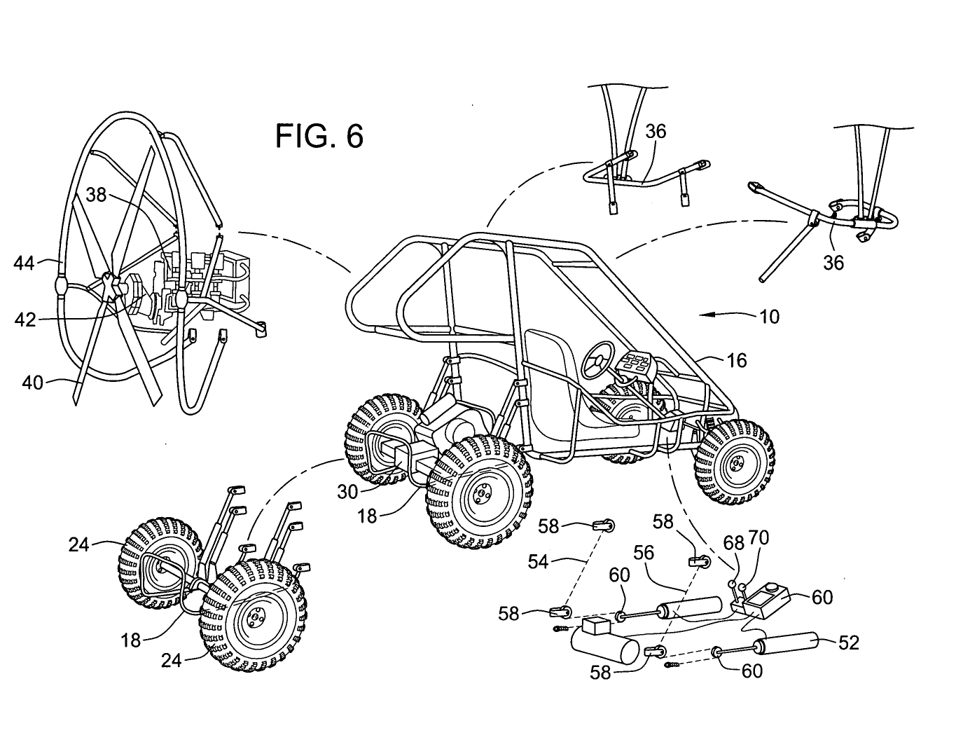

When the vehicle 10 of the first exemplary embodiment is configured for operation only as an aircraft, the ground power engine and transmission 30 can be omitted. Alternatively, as illustrated in FIG. 6, the secondary frame 18 can be replaced with a different secondary frame 18 that does not include provisions for mounting the ground power engine and transmission 30. Where such an alternate secondary frame is used, it may also be desirable to use only one rear wheel, preferably mounted in the middle of the second frame, to reduce weight and cost.

The main frame 16 is constructed primarily of tubing that is welded, brazed, bolted, riveted or otherwise joined together. The main frame 16 of the first exemplary embodiment is generally configured to form a roll-cage construction around a seat 35 for two occupants.

A pair of structures known as outriggers 36 (also known as CG tubes) are attached to the top of the main frame 16. The outriggers 36 are adapted for attachment thereto of brackets 37 that join the chute lines to the main frame 16, when the vehicle 10 is configured for flight. The brackets 37 are configured so that they can be moved fore and aft along the outriggers 36 to obtain proper alignment of the center of gravity of the chassis 12 and the chute 14. In the exemplary embodiment, the outriggers 36 are bolted to the main frame 16. By virtue of this arrangement, the outriggers 36 could be removed when the vehicle 10 is configured for operation only on the ground, as illustrated in FIG. 6.

An aircraft engine 38 is mounted to the rear of the main frame 16, for driving a propeller 40 (alternately known as fan) through a gear box 42. The propeller 40 in the exemplary embodiment is a four bladed prop, but in other embodiments of the invention, the propeller 40 might have fewer or more than four blades. A propeller shroud 44 (alternately known as a fan shroud) is attached to the rear of the main frame 16, for directing the chute 14 and its associated lines away from the propeller 40. The fan shroud 44 of the exemplary embodiment is bolted to the main frame 16, so that it can be removed when the vehicle 10 is configured for only ground operation, in the manner shown in FIG. 6.

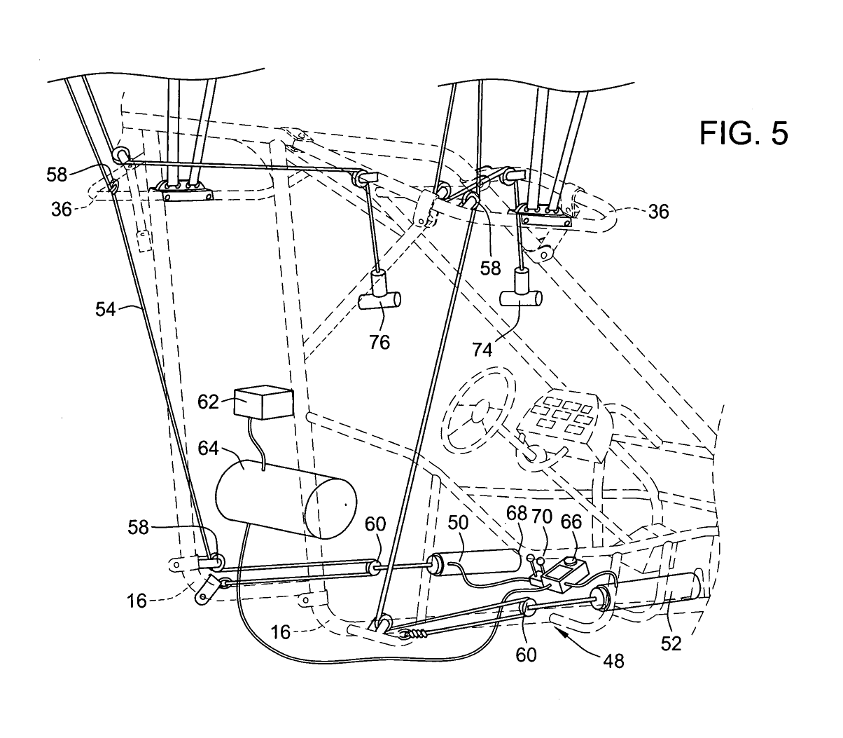

The first exemplary embodiment of the vehicle 10 includes a conventional steering wheel 46 for steering the front wheels 32 during operation on the ground. In the air, the vehicle 10 is steered by a pneumatic actuation system 48, best seen in FIGS. 5 and 6, having a pair of air left and right cylinders 50, 52, mounted along the left and right sides respectively of the main frame 16, for pulling left and right steering lines 54, 56 extending from the chute 14. The steering lines 54, 56 run through fixed pulleys 58 attached to the outriggers 36 and the main frame 16, at a points aft of the air cylinders 50, 52, and loop respectively through a movable pulley 60 attached to an extendable end of the left and right air cylinders 54, 56 respectively. The ends of the steering lines 52, 54 are attached to the main frame 16 at a point aft of the air cylinders 50, 52. By virtue of this arrangement, the steering lines are doubled back in such a manner that when the movable pulleys 60 are moved fore and aft a given distance by the air cylinders 50, 52, one or both of the steering lines will be pulled or released and moved a distance equal to approximately twice the distance that the movable pulley or pulleys 60 are moved by the air cylinders 50, 52.

The pneumatic steering actuation system 48 also includes an on-board compressor 62, a compressed air storage tank 64, and a control valve 66. The steering control valve 66 includes a left and a right steering control lever 68, 70 that can be moved to one of three positions. When the left control lever 68 is pulled to the rear, or first position, the control valve 66 will open to retract the left cylinder 50 to pull on the left steering line 54 for steering the vehicle 10 to the left while the vehicle 10 is in flight. Conversely, when the right control lever 70 is pulled to the rear, or first position, the control valve 66 will open to retract the left cylinder 50 to pull on the right steering line 56 for steering the vehicle 10 to the left, when the vehicle is in flight. In the center position, for both the left and right control levers 68, 70, the control valve 66 is closed to hold pressure in the air cylinders 50, 52. To release pressure in the cylinders 50, 52, and tension on the left or right steering line 54, 56 respectively, the appropriate left or right lever 68, 70 is moved to the third, or forward, position to allow air pressure in one or both of the air cylinders 50, 52 to bleed off .

The left and right control levers 68, 70 can be operated independently to set a desired turning rate, or to compensate for wind drift. The levers 68, 70 can also be operated together for returning the vehicle 10 to straight flight by moving them to the third position, or to flair the canopy 14 for landing by moving them both simultaneously to the rear just prior to landing.

For safety purposes, and to allow sharper turns to be made, the steering lines 54, 56 each include a hand toggle 72, 74 that can be grasped and pulled to steer the vehicle 10 in flight.

The first exemplary embodiment of the invention includes a foot operated accelerator pedal (not shown) that is operatively connected to control the throttles of both the ground power and aircraft engines 30, 38. Normally only one of the engines 30, 38 or the other will be operating at a given time, with the throttle of the non-operating engine 38, 30 being actuated by operation of the accelerator pedal but not having any effect on the non-operating engine. The accelerator pedal is connected to the engines 30, 38 by either a pair of separate control cables, or in the alternative by a single cable running from the accelerator pedal to a splitter mechanism, located adjacent the engines 30, 38, with separate cables running from the splitter to each engine 30, 38. In alternate embodiments of the invention, other engine speed control apparatuses and arrangements can also be used.

As shown in FIG. 4 the first exemplary embodiment of the vehicle 10 also includes a hydraulically actuated disk brake arrangement, having a brake rotor 78 attached to the rear axle 26 and a brake caliper 80 attached to the secondary frame 18. Hydraulic brakes are provided, rather than the more typical cable-pull caliper brakes generally used on prior powered parachutes, because considerably more braking capability is required when the vehicle 10 is operating on the ground, as an ATV, than would be required for braking of a typical prior powered parachute.

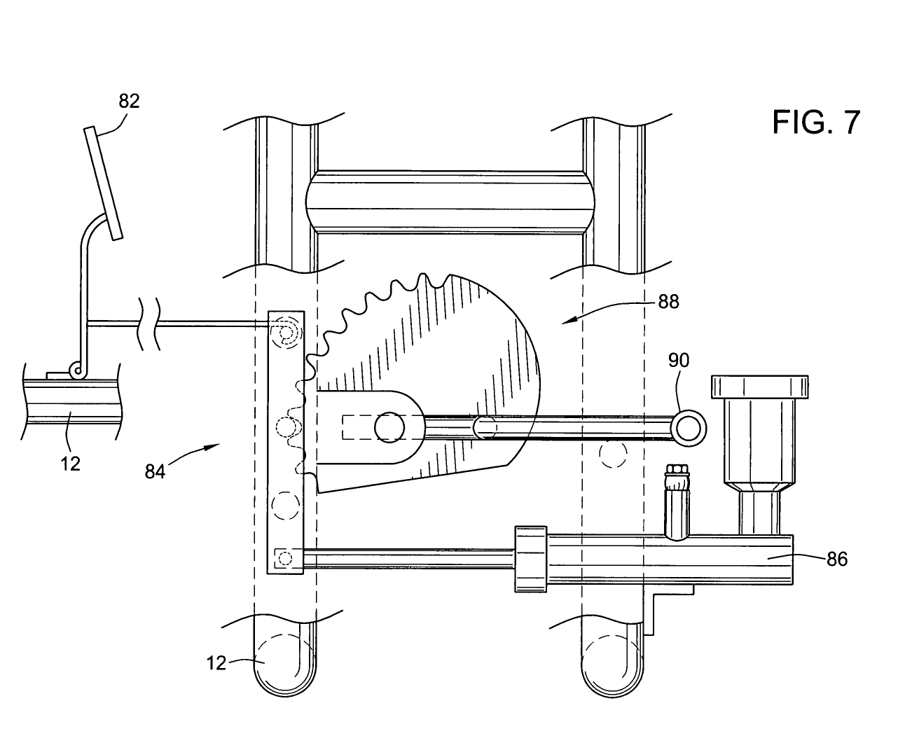

The hydraulic brake is used during both ground powered operation and during operation with the aircraft engine 38. The vehicle 10 includes a brake pedal 82 (shown schematically in FIG. 7) mounted on the main frame 12, and connected via a brake linkage apparatus 84 to a master cylinder 86, which is also mounted on the main frame 12. The brake linkage apparatus 84 includes a locking mechanism 88 for locking the brake to hold the vehicle 10 in place during engine warm-up. The locking mechanism 88 in the exemplary embodiment includes a ratchet-and-pawl arrangement with a manually operable brake locking and release lever 90 that is accessible from the left side of the vehicle 10 by a person standing next to the vehicle 10 or to a person seated in the vehicle 10.

The main frame 12 of the exemplary embodiment of the vehicle 10 includes a floor pan 92 that serves a dual function of closing the bottom of the passenger area of the vehicle 10 and acting as a glide shield for improving airborne performance of the vehicle 10. In other embodiments of the invention, the main frame 12 and/or other structures such as the secondary frame 18 and propeller shroud 44 may include additional fairings or airfoil surfaces to provide an enhanced glide shield configuration, or for other purposes such as improved handling, safety, fuel economy, longer engine life, etc., during operation on the ground or in the air, or both.

Those having skill in the art will recognize that the present invention has many advantageous applications. The exemplary embodiments of the invention described herein essentially combine a powered parachute, which is propeller driven using a ram air chute for its wing for flying, with an ATV or dune buggy, which has a separate motor for ground capabilities and a 4-wheeled suspension to handle rough off-road terrain.

On the ground it is anticipated that a vehicle 10 according to the first embodiment of the invention, the invention will normally be configured to travel over unimproved terrain at a maximum speed of 30 to 35 miles per hour as an ATV, while being powered with the ground propulsion apparatus, but the configuration of the vehicle 10 allows safe operation on the ground at significantly higher speeds. As a flying vehicle, the airspeed will be around 35 to 40 mph. Those skilled in the art will also recognize that the vehicle 10 can be propelled on the ground with the propeller 40 driven by the aircraft engine 38. Although this could not be done on a roadway where propeller-driven operation is prohibited, on flat level terrain, the vehicle 10 can be propelled by the propeller 40 and aircraft engine 38, and has been shown to be highly controllable at speeds up to 70 miles per hour, by virtue of the construction of the vehicle 10. Attempts to operate prior powered parachutes on the ground as ATVs have typically not been controllable or operable at speeds exceeding a few miles per hour, regardless of whether the powered parachute included a tricycle-type three wheeled chassis or a four wheeled chassis.

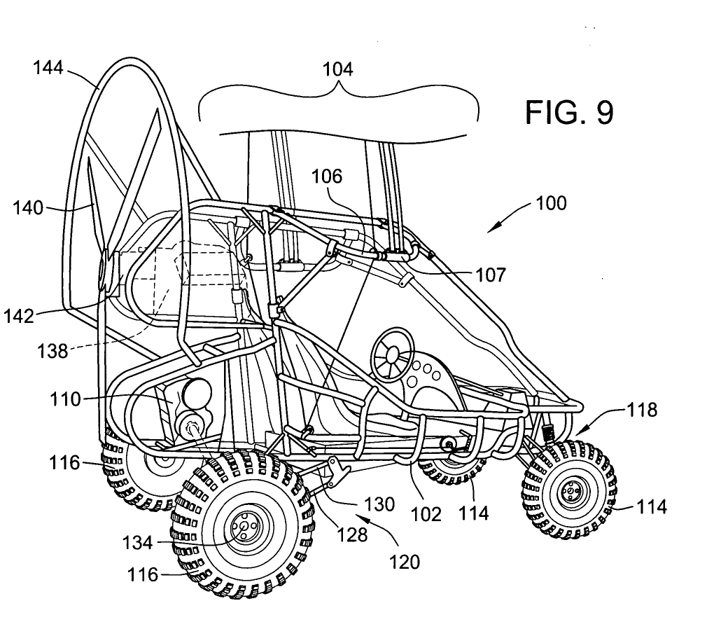

FIGS. 9-15 show a second exemplary embodiment of a vehicle 100, according to the invention, in the form of a flying ATV of a larger size providing significantly more ground clearance, higher operating speeds both on the ground and in the air, and more cargo carrying capability than the first exemplary embodiment of the invention described above in relation to FIGS. 1-8. Many aspects and features of the second embodiment of the flying ATV 100 bear substantial similarity to the aspects and features described above in relation to the first exemplary embodiment of the flying ATV 10.

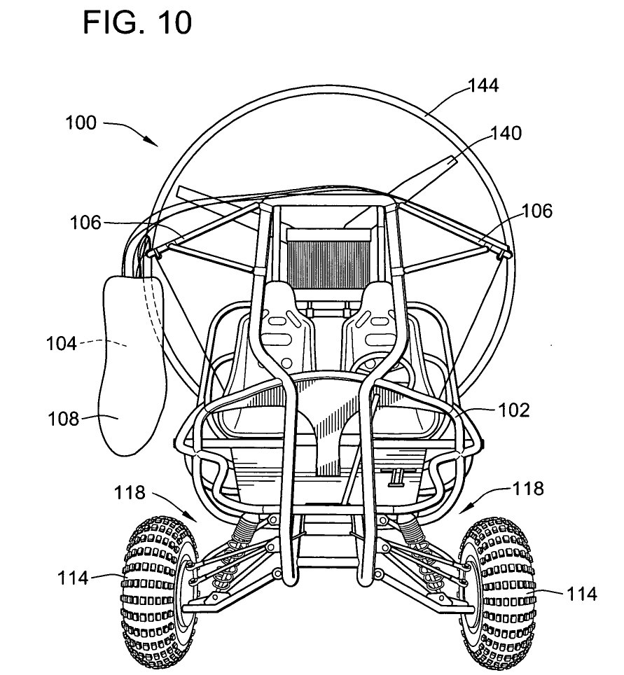

As shown in FIGS. 9 and 10, the vehicle 100 includes a chassis 102 and a parachute 104 operatively attached to the chassis 102 by outriggers 106, in a manner similar to that described above for attaching the parachute to the chassis in the first exemplary embodiment of the invention described above. In FIG. 9, the parachute 104 is illustrated in a deployed position. In FIG. 10, the parachute is illustrated as packed inside of a storage bag 108, suspended from one of the outriggers 106.

The second exemplary embodiment of the flying ATV 100 does not include a primary and a secondary frame, as utilized in the first exemplary embodiment 10 described above. Rather than having the ground propulsion unit, brake, and rear wheels mounted on a pivoting secondary frame, as utilized in the first exemplary embodiment 10 of the invention, in the second exemplary embodiment of a flying ATV 100, according to the invention, the chassis 102 is of one-piece construction, with the ground propulsion unit 110, and front and rear wheels 114, 116 attached directly to the chassis 102. Specifically, the front and rear wheels 114, 116 are attached to the chassis 102 by front and rear independent suspension systems 118, 120, as illustrated in FIGS. 9-11.

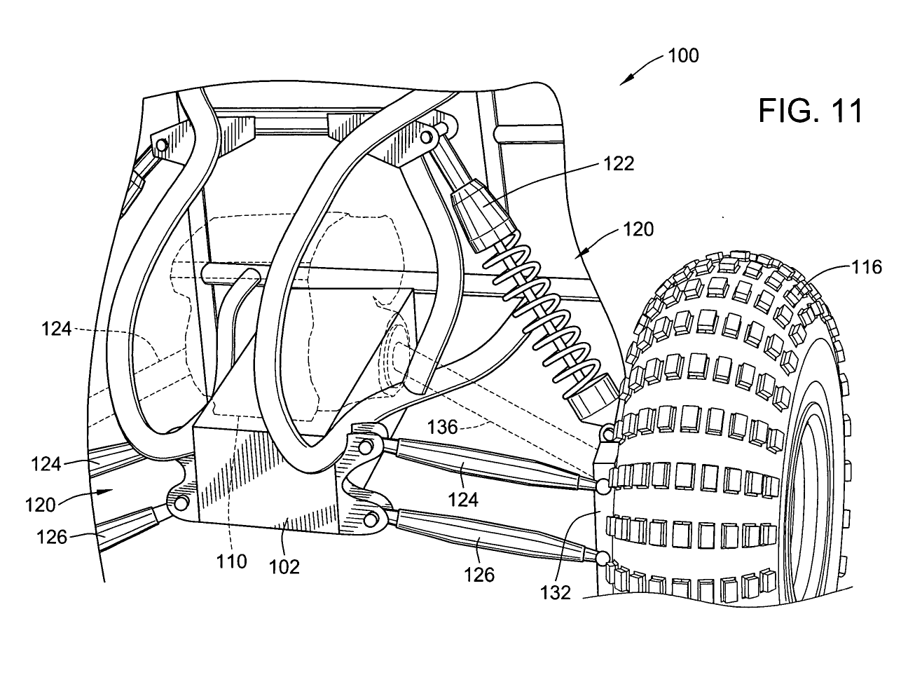

As shown in FIG. 11, the rear independent suspension systems include a compressible strut 122, and several articulating links 124, 126, 128, 130, connecting a rear steering knuckle 132, with two forwardly extending articulating links 130, 132 being shown only in FIG. 9. A rear wheel hub 134 attached to a rear wheel axle (not shown) extends through each of the rear knuckles 132, for attachment to a drive shaft apparatus 136, indicated schematically in dashed lines in FIG. 11, which operatively connects the drive axle of each rear wheel to the ground propulsion unit 110. The right and left rear wheels 116, are each respectively attached to the rear wheel hub 134 at the right and left rear corners of the vehicle, to be driven by the ground propulsion unit 110 via the rear wheel drive shafts 136. Where it is desired to provide a version of the second exemplary embodiment of a vehicle 100, according to the invention, for use in the air only, the ground propulsion unit 110, and rear wheel drive shafts 136 are not provided, and a simplified rear wheel hub and axle assembly may be utilized which does not include provisions for attachment of a drive shaft at an inboard end thereof.

For versions of the second exemplary embodiment of a vehicle 100, according to the invention, which are initially provided without a ground propulsion unit 110 and associated equipment such as the rear wheel drive shafts 136, a retrofit kit may be provided, according to the invention, which includes the ground propulsion unit 110, the rear wheel drive shafts 136, replacement hubs and axles 134, and any other controls, fuel lines, etc. as may be required to retrofit the vehicle 100 to add the capability of operation on the ground using a ground propulsion unit 110, according to the invention.

As shown in FIG. 9, the second exemplary embodiment of a flying ATV 100, according to the invention, also includes an aircraft engine 138 mounted to the rear of the chassis 102, for driving a propeller 140 (alternately known as a fan) through a gearbox 142. The propeller 140 in the second exemplary embodiment is a 3-bladed prop, but in other embodiments of the invention, the propeller 140 might have fewer or more than three blades.

A propeller shroud 144 (alternately known as a fan shroud) is attached to the rear of the chassis 102, for directing the chute 104 and its associated lines away from propeller 140. As was the case in the first exemplary embodiment of the invention, the fan shroud 144 of the second embodiment of the vehicle 100, according to the invention, is preferably bolted to the chassis 102, so that it can be removed when the vehicle 100 is configured for only ground operation.

In a manner similar to that described above, in relation to the outriggers and brackets utilized for attaching the chute to the main frame of the first exemplary embodiment of the invention, the chute 104 in the second embodiment of a vehicle 100, according to the invention, is attached to the chassis 102 by a pair of brackets 107 bolted to the outriggers 106 in such a manner that the brackets 107 can be moved fore and aft along the outriggers 106 to obtain proper alignment of the center of gravity of the chassis 102 and the chute 104. By virtue of this arrangement, the outriggers 106, and brackets 107 may be removed when the vehicle 100 is configured for operation only on the ground. Alternatively, the outriggers may be left in place during ground operation and utilized for carrying cargo, attachment of additional lighting, or in the case of military applications, mounting or transportation of items such as armament, or munitions.

The second exemplary embodiment of the vehicle 100 includes a conventional steering wheel 146, operatively connected to the front wheels 114, 114, for steering the front wheels 114 during operation on the ground.

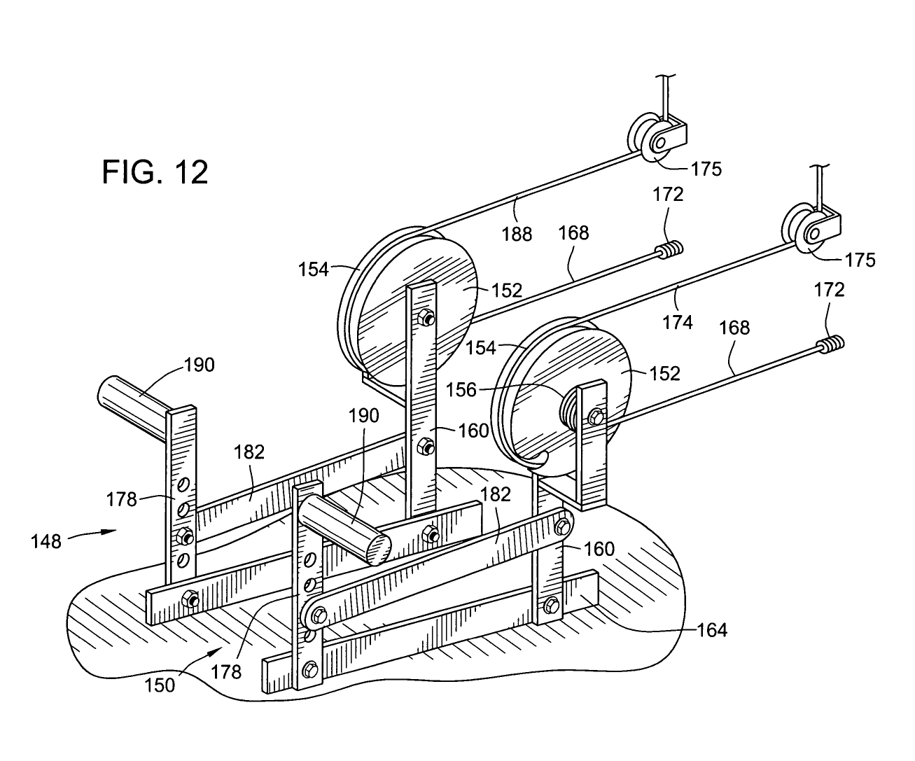

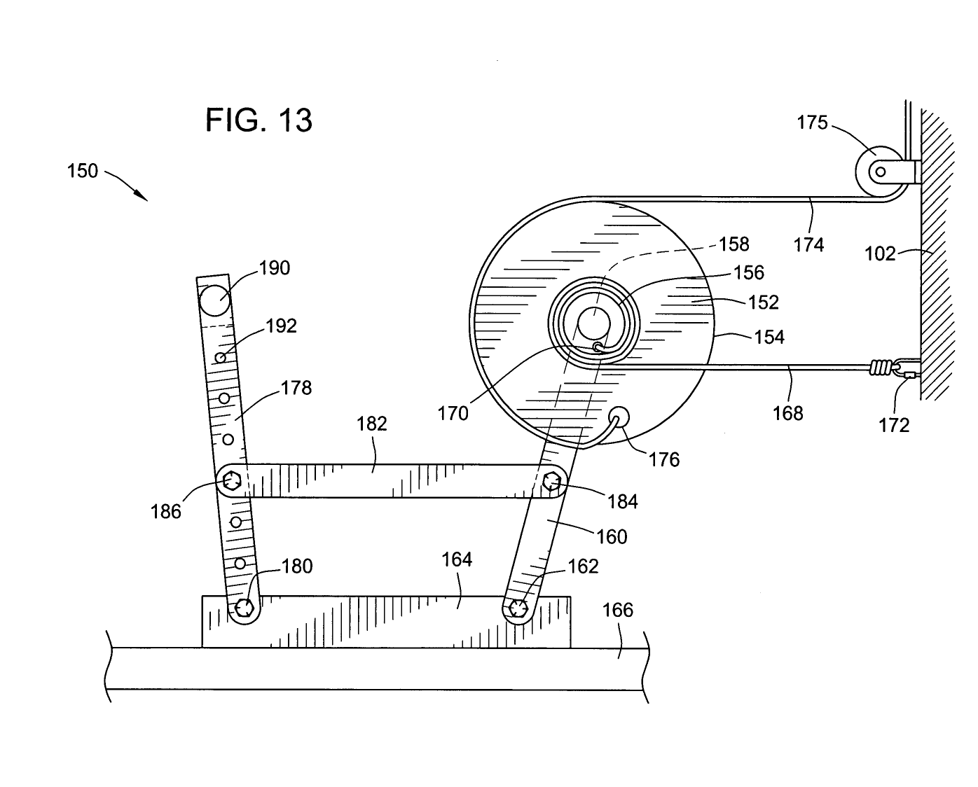

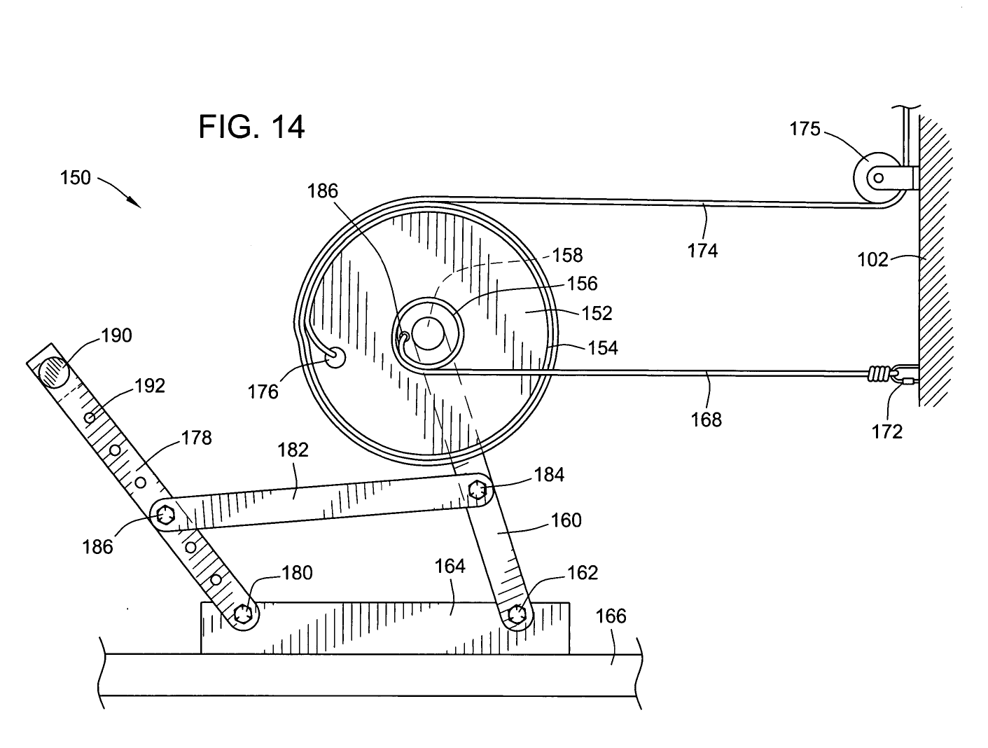

For steering the vehicle 100 in the air, the second exemplary embodiment of the vehicle 100 includes a right and left-foot pedal operated actuator apparatus 148, 150 as shown in FIGS. 12-14. Construction and operation of the right and left foot-pedal actuated actuator apparatuses 148, 150 are essentially identical, and accordingly FIGS. 13 and 14 show only the left actuator apparatus 150 to illustrate the construction and operation of both actuator apparatuses 148, 150.

As shown in FIGS. 12-14, each of the right and left steering actuators 148, 150 includes a stepped mandrel, in the form of a stepped pulley 152 having a large and a small peripheral portion thereof 154, 156. The stepped pulley 152 is rotatably mounted to a distal end 158 of a steering lever 160 having a pivoted end 162 thereof, pivotably attached to an actuator bracket 164 extending upward from a floor plate 166 of the chassis 102.

A first end 170 of a steering actuator chord 168 is affixed to the small peripheral section 156 of the stepped pulley 152 and wrapped several times around the small peripheral section 156 of the stepped pulley 152 in a first wrap direction, i.e. in a counter-clockwise direction as shown in FIG. 13, when the pulley 152 is in a neutral position as shown in FIG. 13. A second end 172 of the steering actuator chord 168 is tied-off, or otherwise attached to a portion of the chassis 102, in the manner shown in FIG. 13. The distal end of the left steering line, from the chute 104, is directed through a guide pulley 176 attached to the chassis 102, and wrapped partially around the larger peripheral section 154 of the stepped pulley 152, in an opposite (i.e. clockwise direction as shown in FIG. 13) and then fixedly attached to the large peripheral section 154 of the stepped pulley 152, as indicated at 176.

The lower end of a steering pedal lever 178 is pivotably attached to the actuator bracket 164, as indicated at 180 in FIGS. 12-14. A steering actuator link 182 has a first end 184 thereof pivotably attached to the steering lever 160, and a second end 186 thereof pivotably attached to the steering pedal lever 178. As previously stated, and illustrated by FIGS. 14-16, the components of the left and right steering apparatuses 148, 150 are identical to one another, but assembled in opposite directions, with the left steering line 174 being attached to the large peripheral section 154 of the stepped pulley 152 of the left steering actuator 150, and the right steering line 188 from the chute 104 being wrapped around and attached to the large peripheral section 154 of the right steering actuator apparatus 148.

FIG. 13 illustrates the left steering actuator apparatus 150 in a neutral position, whereat the left steering line 174 is not being pulled by the steering actuator apparatus 150. In the neutral position, the steering actuator chord 168 is wrapped several times around the small peripheral section 156 of the stepped pulley 152, whereas the left steering line 174 is only wrapped partially around the large peripheral section 154 of the stepped pulley 152.

When the pilot presses on the left foot pedal 190, attached to the distal end of the left steering pedal lever 178, the left steering actuator apparatus 150 moves from the neutral position, as illustrated in FIG. 13, toward a fully actuated position, as illustrated in FIG. 14. By virtue of the construction and interconnection of the components of the steering actuator apparatus 150, according to the invention, as the left steering pedal 190 is moved forward, from the neutral position, the corresponding pivoting motion of the steering pedal lever 178 causes the steering actuator link 182 to pull on the steering lever 160, and cause a proportional forward pivoting motion of the steering lever 160, which in turn causes the distal end 158 of the steering lever 160 to move forward a distance proportional to the forward movement of the brake pedal 190.

As the distal end 158 of the steering lever 160 moves forward, the steering actuator chord 168 causes the stepped pulley 152 to rotate (in a counter-clockwise direction as illustrated in FIG. 14) as the steering actuator chord 168 unwinds from the small peripheral section 156 of the stepped pulley 152. Because the distal end of the steering line 174 is wrapped around the large peripheral section of the stepped pulley 152 in a direction opposite from the winding direction of the steering actuator chord 168, (i.e. clockwise in FIG. 14) as the steering actuator chord 168 unwinds, an additional length of the steering line 174 is wound into the large peripheral section 154 of the stepped pulley 152, as the actuator apparatus 150 moves from the neutral position shown in FIG. 13 toward the fully actuated position shown in FIG. 14.

The difference in peripheral lengths of the large and small peripheral sections 156, 154 of the stepped pulley 152 results in a substantially longer length of the steering line 164 being wound onto the pulley 152 than the length of the steering actuator chord 168 which is unwound for a given movement of the brake pedal 190. In this manner, a relatively small brake pedal travel 190 of five to six inches, for example, can result in thirty inches or more of the steering line 174 being wound onto the large peripheral section 154 of the stepped pulley 152.

When foot pressure is removed from the brake pedal 190, aerodynamic forces acting on the chute 174, which create tension in the steering line 174, will cause the steering line 174 to pull the brake actuator apparatus 150 back toward the neutral position illustrated in FIG. 13. As the steering actuator apparatus 150 moves back toward the neutral position, the steering control line 174 causes the stepped pulley 152 to rotate in the clockwise direction, as illustrated in FIGS. 12-14, to thereby unwind the distal end of the steering line 174 from the stepped pulley 152 and simultaneously rewind the steering actuator cord 168 small peripheral section 156 of the stepped pulley 152.

In the exemplary embodiment of the steering actuator apparatuses 148, 150 shown in FIGS. 14-16, the brake pedal lever 178 includes a plurality of holes 192 which can be used for connection to the second end 186 of the steering actuator link 182. By moving the connection point between the steering actuator link 182 and the steering pedal lever 178 from one hole 192 to another along the steering pedal lever 178, the amount of force and pedal travel required for a given length of the steering line 174 to be wound onto the stepped pulley 152, can be adjusted to thereby accommodate the needs and preferences of a particular pilot. By virtue of this arrangement, the pedal travel required to wind a given length of the steering line 174 onto the stepped pulley 152 may be reduced with a corresponding increase in the amount of force that needs to be applied to the pedal 190, or conversely, the force which must be applied to the pedal 190 may be reduced with a corresponding increase in pedal travel.

Those having skill in the art will recognize, that in other embodiments of the invention, either or both of the steering pedal lever 178 and steering lever 160, may include a plurality of holes for making similar adjustments in the operation of a steering actuator apparatus, according to the invention. In similar fashion, in other embodiments of the invention, the steering actuator link 182 may include a plurality of holes for making such an adjustment. In yet other embodiments of the invention, other means may be provided for changing the mechanical connection, and thereby the mechanical advantage provided by the configuration and connection of the various components of a steering actuator apparatus according to the invention.

It will be understood, that in other embodiments of the invention, the specific details of construction and connection of a foot powered steering actuator apparatus, according to the invention, may differ significantly from those described above, within the intended scope of the invention. For example, rotatable mandrels having a shape other than that provided by the round pulleys of the exemplary embodiment may be utilized. For example, a square or hexagonal, or asymmetric periphery may be utilized to provide additional tailoring of operation of the actuator. Furthermore, it is intended that the term “steering actuator chord” include other types of tensile devices, such as web straps, wires, cables, chains, and belts.

It will further be understood that a pneumatic steering apparatus of the type described in relation to the first exemplary embodiment of a vehicle 10, according to the invention, or a foot-powered actuator apparatus of the type described in conjunction with the second exemplary embodiment of a vehicle 100, according to the invention, may be utilized in powered parachute-type vehicles other than the flying ATV disclosed herein. A pneumatic actuator apparatus, according to the invention, for example, may provide significant advantage to paraplegic pilots wanting to participate in the flying of a standard powered parachute-type vehicle. In similar fashion, it is not intended that the term “foot-powered actuator apparatus” in describing a steering actuator apparatus, according to the invention, limit the scope of the invention to only foot-powered actuators. It is contemplated that in other embodiments of the invention, for example, some or all of the aspects and functions provided by the foot-powered actuator apparatus 148, 150 may be incorporated into other embodiments of an actuator apparatus, according to the invention in which hand levers might replace the foot pedals, or other types of mechanical, pneumatic, hydraulic, devices, or some combination thereof might be utilized in practicing a steering actuator apparatus according to the invention.

In the second exemplary embodiment of a flying ATV 100, a hand operated throttle (not shown) is provided for controlling speed of the aircraft engine, so that both of the pilot's feet free to operate the right and left brake pedals 190.

In the second exemplary embodiment of the flying ATV 100, the throttles of the ground power unit 110 and aircraft engine 138 are not connected to a common throttle control, as was the case in the first exemplary embodiment of the flying ATV 10 as described above. The throttle cable of the ground power unit 110 in the second exemplary embodiment of the vehicle 100 is attached to a traditional floor board mounted accelerator pedal (not shown). A floor board mounted brake pedal (not shown) is also provided for actuating disc brakes (not shown) operating to control mounted on each of the rear wheels 116. A hand operated brake lever may also be provided, in some embodiments of the invention, for use in actuating the disc brakes during take off, landing, and taxiing of the flying ATV 100 so that the pilot may simultaneously operate the brakes and the steering pedals 190.

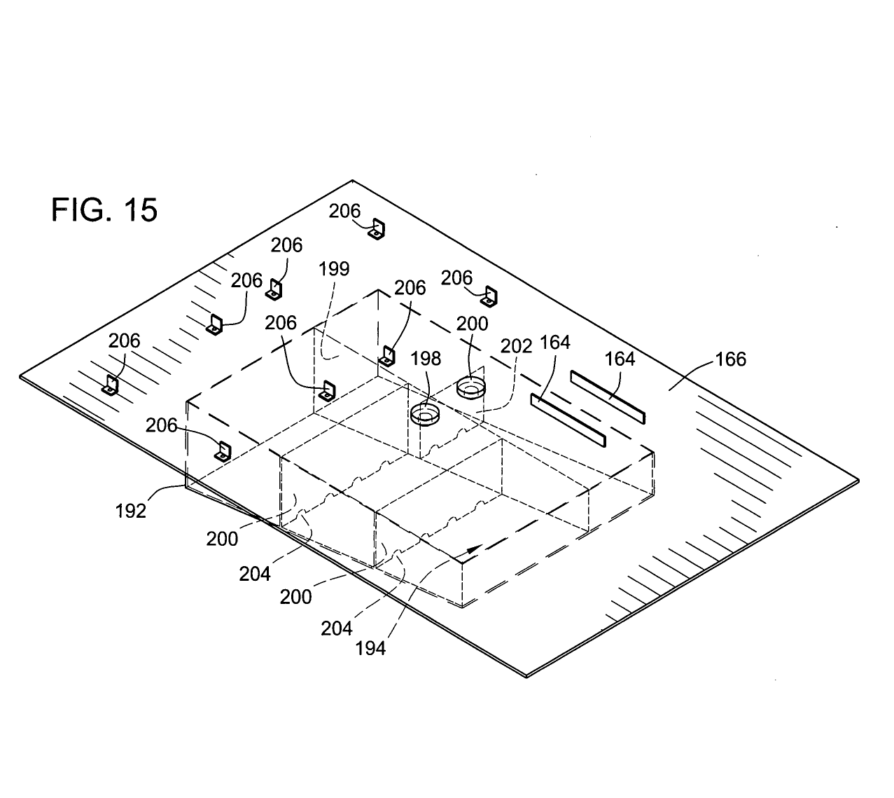

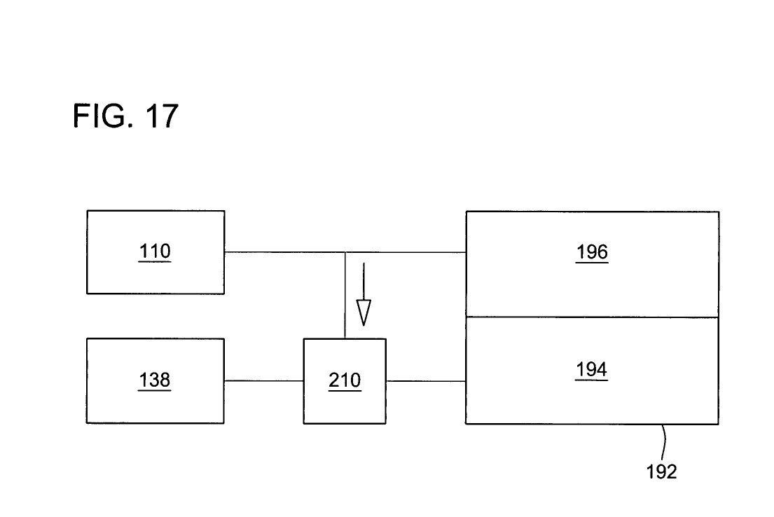

As shown in FIG. 15, the second exemplary embodiment of the vehicle 100 further includes a dual compartment fuel tank 192 integrally attached to the bottom side of the floor panel 166. The fuel tank includes a large fuel compartment 194 and a small fuel compartment 196, each having a respective filler cap 198, 200. The large and small fuel compartments are separated from one another by a common wall 199, and each include one or more internal baffles 200, 202 having a plurality of passages there through, as indicated by the notches 204 in FIG. 17, which allow fuel to move in a somewhat restricted manner fore and aft in the large and small fuel compartments 194, 196. Preferably, the top surface of the fuel tank 192 is formed by the floor plate 166, and the lower surface of the fuel tank 192 is slopped from front to rear, to provide a natural sump area in the rear portion of both the large and small fuel compartments 194, 196.

By virtue of the positioning of the internal and external substantially vertically oriented walls and baffles of the fuel tank 192, and its positioning under and integral attachment to the floor plate 166, the fuel tank 192 provides significant structural support to the floor plate 166, and also to the overall chassis 102, when the floor plate 166 and fuel tank 192 are mounted in the remainder of the chassis 102. Those having skill in the art will recognize that, by virtue of the construction of the fuel tank 192 and floor plate 166, in accordance with the invention, the fuel tank 192 is no longer just dead weight on the chassis, but also performs a structural role, allowing the overall complexity and weight of the chassis 102 to be reduced. The actuator brackets 164 and other brackets 206, for attaching additional items such as seats, may also be integrally formed with or joined to the floor plate 166, without the necessity for structural ribs, etc., or additional under-floor structural support, because the support that would otherwise be necessary to stiffen the floor plate 166 in the vicinity of such brackets 164, 206 is provided by the structure of the fuel tank 192, according to the invention.

It is contemplated that in high volume production, it may be desirable to mold or otherwise fabricate the fuel tank 192 and floor plate 166 as an integral modular unit, from a material such as a plastic. If necessary, to provide resistance to localized high stresses, brackets attached to the floor plate may include metal inserts, in an otherwise plastic assembly, or may be formed entirely of a metallic or high strength composite material which is molded into or adhesively joined to such a plastic fuel tank/floor plate assembly.

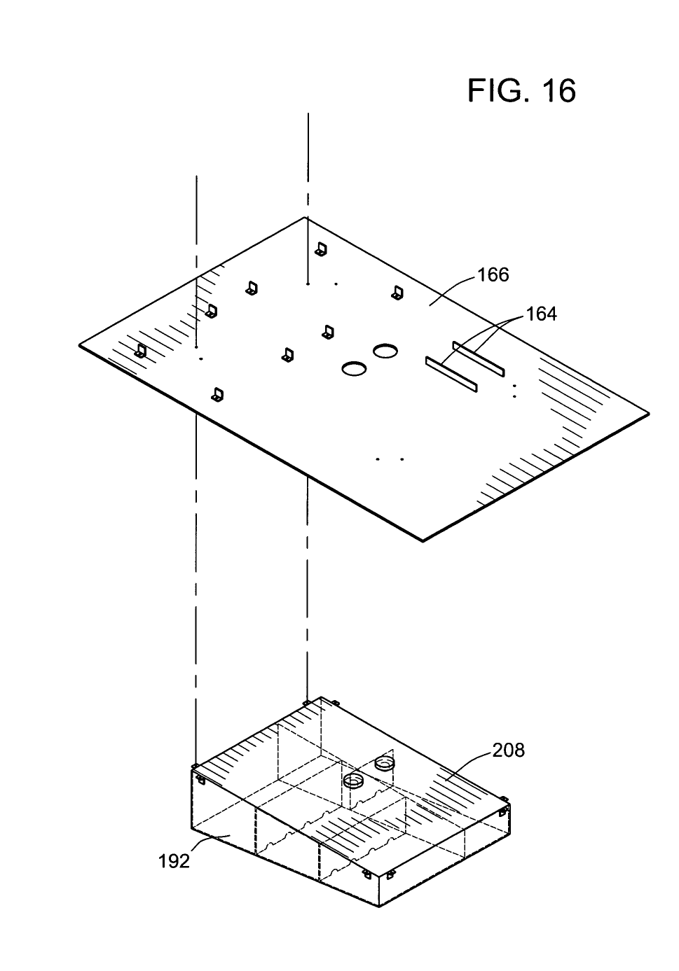

An integrated floor plate and fuel tank assembly, may also be fabricated from metal materials, or a combination of plastic and metal materials, according to the invention. For example, as shown in FIG. 16, the fuel tank 192 is fabricated separately from the floor plate 166 and includes its own top panel 208. The fuel tank 192 is adapted to be joined by fasteners, or other appropriate means to the bottom surface of the floor plate 166. In this manner, different materials may be used for the floor plate 166 and the fuel tank 192, while still maintaining the structural advantages of having the fuel tank 192 placed directly under the floor panel 166 and integrally joined thereto. Such an arrangement might be used, for example, in embodiments of the invention where it was desirable to fabricate the entire tank from metal materials of a fairly thin gauge. In such embodiments, if the vertical side walls of the fuel tank 192 were continuously welded directly to the floor plate 166, considerable warpage of the floor plate 166 might occur.

Configuring and positioning the fuel tank 192, in accordance with the invention, also provides an additional advantage in that the lower surface of the fuel tank can perform an additional function as part of a glide shield for the flying ATV. In this regard, the fuel tank may further include additional fasteners, structural elements, or shapes for its external surfaces to facilitate attachment of and structural support for other components of such a glide shield, or to function in conjunction with such other components of a glide shield.

The construction of the fuel tank 192 and the exemplary embodiment of the vehicle 100 was selected to provide several additional advantages, and be compatible with the selection of the ground propulsion unit 110, and aircraft engine 138 utilized in the vehicle 100. The aircraft engine 138, in the exemplary embodiment of the vehicle 100, includes an oil injection circuit, and is thus capable of operating from a supply of gasoline, which is stored in the large fuel compartment of the fuel tank 192. Ground propulsion units, of the type suitable for use in a flying ATV, according to the invention, are generally only available at reasonable cost in a form that includes a two-cycle engine without an oil injection circuit, which thereby requires that the fuel supplied to the ground propulsion unit 110 be a premix of gasoline and oil. The small fuel compartment 196 of the fuel tank 192 is connected directly to the ground propulsion unit 110, and used for supplying a premix of gasoline and oil to the two-cycle engine of the ground propulsion unit 10. The large fuel compartment 194 is connected to the aircraft engine 138 for supplying gasoline only, carried in the large fuel compartment 194, to the engine 138, with the mixing of oil into the gasoline being accomplished at the aircraft engine 138 by its oil injection circuit.

As shown in FIG. 17, however, the exemplary embodiment of the vehicle 100 includes a one-way fuel bypass apparatus 210 which can be actuated to allow the premix in the small fuel compartment 196 to be selectively transferred into the large fuel compartment 194, and/or fed directly to the aircraft engine 138, to thereby allow the small fuel compartment 196 to be used as a reserve tank, given that the aircraft engine 138 is capable of running on the premix carried in the small fuel compartment 196. Preferably, the fuel bypass control is uni-directional in the exemplary embodiment of the vehicle 100, so that the large fuel compartment 194 cannot be connected in fluid communication with the ground power unit 110, given that the two-cycle engine of the ground power unit 110 could be seriously damaged by an inadvertent or uninformed attempts to operate it with the gasoline stored in the large fuel compartment 196.

In embodiments of the invention having only the ground propulsion unit 110 or alternatively only the aircraft engine 138, it may still be desirable to utilize a dual compartment tank 192, in order to reduce inventory requirements and the cost of mass production. In such single-engine embodiments, having a fuel tank including two fuel compartments, both compartments may simply be connected together, or an alternate fuel bypass arrangement may be provided to allow both compartments in the fuel tanks to be commonly connected to one another and the engine. Alternatively, it may still be desirable to connect the large fuel compartment 194 of the tank 192 to the engine, and provide a selective fuel bypass valve, or circuit, so that the small fuel compartment 196 can still be used as a reserve tank, in the manner described above in relation to the second exemplary embodiment of the vehicle 100.

Those having skill in the art will readily recognize that the invention provides considerable advantage, in comparison to prior vehicles which were basically limited to operation either on the ground or in the air, but not both. For example, military forces around the world use conventional dune buggies, having only ground operating capabilities. An ATV or dune buggy that can actually fly adds another dimension to its use. Such a vehicle can fly over swamps or rivers, or can be dropped using a first parachute into remote areas and then fly back out after driving to a safe take-off location, and replacing the drop chute with a second parachute configured for operation of the flying ATV as a powered parachute.

In civilian use, farmers, ranchers, hunters, wilderness explorers, fishermen, or others who want the extra versatility of having a vehicle that can be driven on the ground and flown, finally have such a vehicle available to them. Some of the most beautiful country in the world cannot be accessed directly by land. There are some regions in remote mountainous regions, or on islands, for example that are not accessible by road. A person operating a vehicle according to the invention could fly into these remote areas, and once on the ground, could explore the area using the ground capabilities of the vehicle. Once finished the vehicle can readily fly back out to civilization.

Also, having the ability to truly travel on land greatly expands the capability of powered parachutes for cross-country travel. Presently, a powered parachute traveling cross country must land on an air field that is effectively in walking distance from a supply of fuel, when it is necessary to stop for fuel. A vehicle according to the invention can be landed in many other locations, and then driven to a gas station or other source of fuel for refueling. After refueling, the vehicle can be driven back to the place of landing, or another location suitable for take-off, and the cross-country trip by air can be continued.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any element not expressly described herein as being essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expect skilled artisans to employ such variations as appropriate, and the inventor intends for the invention to be practiced otherwise than as specifically described herein.

The inventor anticipates that such variations may include utilizing some or all of various aspects of the present invention, stating alone, or in combinations other than expressly disclosed herein with respect to the preferred embodiments. Accordingly, this invention includes all modifications and equivalents of the subject matter recited or suggested herein as permitted by applicable law. Moreover, any combination of the above-described elements in all possible variations thereof is encompassed by the invention unless otherwise indicated herein or otherwise clearly contradicted by context.

What is claimed is:

1. A flyable all terrain vehicle (ATV) configured for controlled powered operation on the ground over rough terrain, or in the air, or both on the ground and in the air, the flyable vehicle comprising:
an ATV configured for powered controllable operation over rough or smooth terrain, including a chassis; and
a powered parachute apparatus operatively attached to the chassis for powered controllable operation of the vehicle in flight and allowing the vehicle to take off and land under its own power.

2. The flyable ATV of claim 1, including a first power source mounted on the chassis and operatively attached for engaging the ground to propel the ATV when operating on the ground, and a second power source mounted on the chassis and operatively attached to a propeller for propelling the ATV in flight and during take-off and landing of the flyable ATV.

3. The flyable ATV of claim 1, wherein the powered parachute apparatus includes steering lines, further comprising, a steering actuator apparatus operatively connected to the steering lines for controlling the ATV in flight and/or during take off and landing, with the steering actuator apparatus comprising a motion amplifying apparatus having an movable control input, and an output element connected one of the steering lines for pulling the steering line a distance greater than a distance of movement of the input.

4. The flyable ATV of claim 3, wherein the steering actuator apparatus further comprises:
one or more guides for directing the steering line; and
a pneumatic cylinder having a stroke defining the output;
the guides directing a distal end of the steering line in a doubled back configuration from a point of attachment of the distal end of the steering line to the chassis into a U-shaped bight passing through a movable end of the pneumatic cylinder, in such a manner that the stroke of the cylinder pulls a length of steering line substantially greater than the stroke when the cylinder is actuated.

5. The flyable ATV of claim 3, wherein the steering actuator included a rotatable mandrel mounted on the distal end of a pivotable steering lever, for pulling a length of the steering line greater than a movement of the distal end of the pivotable steering lever.

6. The flyable ATV of claim 1, wherein the first power source is two-cycle internal combustion engine requiring a premix of gasoline and oil, and the second power source is an internal combustion engine operable on gasoline, and the flyable ATV further comprises:
a dual compartment fuel tank having a first fuel compartment for carrying the premix and a second fuel compartment for carrying gasoline; and
a fuel circuit connecting the first and second power sources to the first and second fuel compartments in such a manner that the premix may be selectively delivered either into the second fuel compartment, or directly to second power source, but precluding delivery of gasoline form the second fuel compartment into the first fuel compartment or to the first power source.

7. The flyable ATV of claim 1, wherein the chassis includes a floor plate, and a fuel tank integrally joined to and disposed beneath the floor plate.

8. A method of marketing a flyable ATV comprising selectively attaching components together to alternatively form an ATV operable on the ground only, a vehicle operable only as a powered parachute, or a vehicle operable on the ground as an ATV or in the air as a powered parachute.

9. The method of claim 1, further comprising, providing an initial configuration of the vehicle operable only on the ground or in the air, and also providing additional components or retrofit kits for subsequent conversion of the vehicle into a vehicle operable on the ground as an ATV or in the air as a powered parachute.

10. A powered parachute comprising:
a controllable ram air parachute having steering lines; and
a pneumatic steering apparatus operatively connected to and for controlling the steering lines.

11. The powered parachute of claim 10, wherein the pneumatic steering apparatus comprises a lever actuated control valve for controlling position of the steering lines.

12. The powered parachute of claim 11, wherein the pneumatic steering apparatus comprises:
one or more guides for directing one of the steering lines; and
a pneumatic cylinder having a stroke;
the guides directing a distal end of the steering line in a doubled back configuration from a point of attachment of the distal end of the steering line to the chassis into a U-shaped bight passing through a movable end of the pneumatic cylinder, in such a manner that the stroke of the cylinder pulls a length of steering line substantially greater than the stroke when the cylinder is actuated.
